(19) United States
(12) Patent Application Publication
(10) Pub. No.: US 2024/0231483 A1
(43) Pub. Date: Jul. 11, 2024

(54) ILLUMINATOR SYSTEM FOR EYE-TRACKING SYSTEM

(71) Applicant: TOBII AB, DANDERYD (SE)

(72) Inventors: PRAVIN KUMAR RANA, DANDERYD (SE); OLA GRIMÅKER, DANDERYD (SE); MÅRTEN SELIN, DANDERYD (SE)

(21) Appl. No.: 18/408,635

(22) Filed: Jan. 10, 2024

(30) Foreign Application Priority Data
Jan. 10, 2023 (SE) 2350006-7

(51) Int. Cl. G06F 3/01; G06V 10/145; G06V 40/18; G06V 40/19

(52) U.S. Cl. CPC G06F 3/013; G06V 10/145; G06V 40/19; G06V 40/197

(57) ABSTRACT

An illuminator system for an eye-tracking system for tracking movements of an eye, the system comprising a plurality of illuminators; wherein each of the plurality of illuminators is configured to emit light forming a respective predetermined reference pattern; wherein each of the reference patterns, when reflected off the cornea of the eye, produces a respective reflected pattern forming a single glint; wherein the reference patterns of at least two of the plurality of the illuminators are different from each other.

### CROSS-REFERENCE TO RELATED APPLICATION

The present application claims priority to Swedish patent application No. 2350006-9, filed Jan. 10, 2023, entitled “ILLUMINATOR SYSTEM FOR EYE-TRACKING SYSTEM”, and is hereby incorporated by reference in its entirety.

### TECHNICAL FIELD

The present invention is directed to an illuminator system for an eye-tracking system for tracking movements of an eye. The illuminator system serves to enable glint detection as well as providing illumination to the eye area.

### BACKGROUND

There is a growing interest in augmented reality (AR) or virtual reality (VR) systems, or more generally extended reality (XR) systems in various applications, including gaming, advertisement, medical, engineering, entertainment and more. These systems may also incorporate tracking of eye movements, i.e., eye tracking.

FIG. 1 shows a prior art eye-tracking system with glint detection. As shown, the eye-tracking system 100′ is provided with an illuminator system 200′. The illuminator system 200′ is provided with a plurality of illuminators 210′. The plurality of illuminators 210′ are arranged roughly in a ring shape surrounding the eye. A camera is provided within the eye-tracking system 100′ and captures images of the eye including any reflections of the light emitted by the illuminators 210′.

The illuminator system 200′ serves two main purposes, namely, to provide illumination to the eye area in order to allow a camera to capture images of the eye, and to project light onto the cornea of the eye so as to produce point-like (specular) reflections of the illuminators 210′. These reflections are referred to as “glints”. Depending on the relative position and orientation of the eye ball, some of the reflections as captured by the camera may fall within the iris/pupil region, while some of them may fall in the white of the eye. The corneal reflections that fall within the pupil/iris region are particularly useful as glints.

The purpose of the glints is to serve as a reference relative to which gaze may be determined. That is, the relative position and orientation of the eyeball may be determined by comparing the apparent position of the iris/pupil relative to the positions of the glints as captured by the camera.

As shown in FIG. 1, the head-mounted eye-tracking system 100′ maybe part of an extended reality (XR) system. Eye-tracking may be useful for detecting what the user of the eye-tracking system 100′ is looking at, and/or may be used for controlling the XR system, or more generally allow the user to interact with a broader system including the eye-tracking system 100′. Through the eye-tracking system 100′, the user may also interact with the real world or a virtual world. As shown, in prior art systems, the illuminators 210′ are simple point light sources, and are typically each implemented by single LEDs. As shown, up to about 10 illuminators 210′ are used, and are arranged to surround the eye.

However, the prior-art illuminator system 200′ shown in FIG. 1 has several drawbacks. For example, in reality, it can be difficult to distinguish the corneal reflections (i.e. glints) of the light emitted by the plurality of illuminators 210′ from other unwanted artefacts. Unwanted artefacts may result from secondary reflections by objects other than the cornea, such as prescription glasses and contact lenses. Unwanted artefacts may also result from external light sources. In situations where the unwanted artefacts resemble glints, “false” glints may be produced. Furthermore, because a large number of illuminators 210′ is required to enable reliable eye-tracking, power consumption tends to be high.

FIGS. 2a and 2b show examples of images captured by the camera of an eye-tracking system. In particular, FIG. 2b shows an image of the eye of a user who is wearing a pair of prescription glasses. As shown in FIG. 2a, there is a relatively few number of areas of high local light intensity, and these areas of high intensity can be readily distinguished from the surroundings and, thus, identified as potential glints. Furthermore, once the pupil position is identified, it is possible to define a boundary (e.g. using a model) within which true glints are expected to be found. For example, the model may define the boundary as the maximum allowed distance from the pupil centre. For another example, the model may define the boundary as the iris circle/ellipse, so that any glint that falls within the iris circle/ellipse may count as a true glint. This serves as another indicator of true glints.

On the contrary, as can be seen in FIG. 2b, it can be difficult to recognise from the reflections which of the speckles of light are genuine glints owing to the high count of areas with high local light intensity, some or all of which may qualify as glint candidates. For example, particularly in augmented reality (AR) applications, external light sources may reach the eye and produce reflections that could appear confusingly similar to the genuine glints. In the case of FIG. 2b where the user is wearing prescription glasses, the prescription glasses may cause additional reflections to be produced and captured by the camera, as is known in the field to cause problems in eye-tracking. Contact lenses may also create similar additional reflections. These additional reflections may come from the plurality of illuminators 210′, or may come from external light sources. Unlike the example shown in FIG. 2a, even after the pupil location has been determined and glint candidates falling outside a boundary around the pupil have been ruled out, an overwhelming number of glint candidates may still remain. In such scenarios, glint detection may fail.

In any event, because these additional reflections are variable and unpredictable, they are not useful as glints and cannot be used as reference for gaze estimation. Furthermore, in reality, the reflections of the illuminators 210′ may not be perfectly sharp images but may be blurred to some unknown extent. Therefore, the apparent size of the reflections may also be unpredictable and cannot be used as a feature for distinguishing genuine glints from artefacts during image processing. This is especially the case because the illuminators 210′ in prior art systems are simple point light sources and do not have any internal features from which the scaling of the reflections could be determined. For example, especially in the case of FIG. 2b, a speckle of reflected light that appears to be larger than expected may be a genuine glint which is blurred by reflection off the cornea, or may be an artefact reflection produced by the prescription glasses worn by the user, and there is no reliable way of distinguishing these two cases from one another.

As a result, in prior-art systems, glint detection is unreliable. When glints are incorrectly detected, incorrect gaze estimation may result and reduce the performance of an eye-tracking system. As a further result, in prior-art systems, glint matching is also unreliable. When glints are matched to the incorrect illuminators 210′, gaze estimation performance may also suffer.

There is thus a desire to improve the reliability of glint detection and/or glint matching, and also to reduce the power consumption of eye-tracking systems.

### SUMMARY OF INVENTION

In accordance with the present invention, there is disclosed an illuminator system for an eye-tracking system for tracking movements of an eye, the system comprising a plurality of illuminators; wherein each of the plurality of illuminators is configured to emit light forming a respective predetermined reference pattern; wherein each of the reference patterns, when reflected off the cornea of the eye, produces a respective reflected pattern forming a single glint; wherein the reference patterns of at least two of the plurality of the illuminators are different from each other.

Each of the plurality of illuminators may comprise a light source; and a cover configured to selectively block light emitted by the light source to form the respective predetermined reference pattern.

The cover may part of a casing of the eye-tracking system.

In each of the plurality of illuminators, the illuminator may further comprise a light guide between the light source and the cover, so that light from the light source passes through the light guide before reaching the cover.

At least two of the illuminators may have a shared light source and a shared light guide, so that light from the shared light source passes through the shared light guide before reaching the respective covers of the at least two illuminators.

In each of the plurality of illuminators, the cover may comprise at least one window configured to allow the light forming the predetermined reference pattern to pass therethrough. The at least one window may be optically diffuse.

The one or more window may be configured to diffuse the light passing therethrough to achieve a substantially uniform light intensity.

Each of the plurality of illuminators may comprise a plurality of light sources positioned to form the respective predetermined reference pattern.

All of the light sources in each of the plurality of illuminators may be positioned to form the respective predetermined reference pattern.

Each of the plurality of illuminators may comprise further light sources which are non-operable and do not form part of the respective predetermined reference pattern.

The plurality of light sources may be arranged in a matrix, and the plurality of light sources may be selectively operable to form the predetermined reference pattern.

Optionally, none of the predetermined reference patterns is a scaled or rotated version of another one of the predetermined reference patterns.

Each of the predetermined reference patterns may have no rotational symmetry.

The reference pattern of each of the illuminators may be at least 2 mm in length and width.

The reference pattern of each of the illuminators may have a length which is not equal to its width.

The plurality of illuminators may comprise at least four illuminators.

There is also disclosed an eye-tracking system comprising the above illuminator system.

The eye-tracking system may comprise an extended reality headset; wherein the illuminator system is attached to or integrated in the extended reality headset.

The plurality of illuminators may be arranged to surround the eye.

The eye-tracking system may further comprise an image sensor configured to capture an image of one or more of the glints.

The eye-tracking system may further comprise a controller having stored thereon the predetermined reference patterns; wherein the controller is configured to recognise the one or more glints present in the captured image; compare the one or more glints with the predetermined reference patterns; and associate each of the one or more glints with a matching one of the predetermined reference patterns.

The controller may be further configured to, for each of the one or more glints: determine the apparent size of the glint; determine the glint as genuine if its apparent size falls within a predetermined size range; and determine the glint as an artefact if its apparent size falls outside the predetermined size range.

According to the present invention, there is also disclosed a method of eye tracking comprising: emitting light from a plurality of spatial positions towards an eye, wherein the emitted light from each of the positions forms a respective predetermined reference pattern; the reference patterns are different from one another; and each of the reference patterns, when reflected off the cornea of an eye, produces a respective reflected pattern forming a single glint; capturing an image of one or more of the glints; recognising the one or more glints present in the captured image; comparing the one or more glints with the predetermined reference patterns; and associating each of the one or more glints with a matching one of the predetermined reference patterns.

The method may comprise, for each of the one or more glints: determining the apparent size of the glint; determining the glint as genuine if its apparent size falls within a predetermined size range; and determining the glint as an artefact if its apparent size falls outside the predetermined size range.

According to the present invention, there is also disclosed a computer program comprising instructions to cause the above system to execute the steps of: capturing an image of one or more of the glints; recognising the one or more glints present in the captured image; comparing the one or more glints with the predetermined reference patterns; and associating each of the one or more glints with a matching one of the predetermined reference patterns.

The computer program may comprise further instructions to cause the system to execute the steps of determining the apparent size of the glint; determining the glint as genuine if its apparent size falls within a predetermined size range; and determining the glint as an artefact if its apparent size falls outside the predetermined size range.

There is also disclosed a computer-readable medium having stored thereon the computer program above.

### BRIEF DESCRIPTION OF THE DRAWINGS

FIG. 1 depicts a prior-art eye-tracking system.

FIGS. 2a and 2b depict images of the eye captured for eye-tracking in prior-art systems.

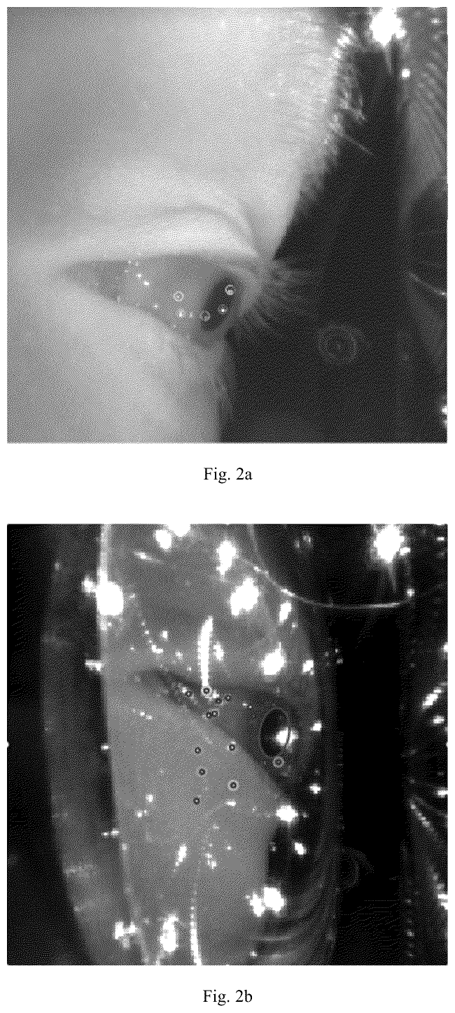

FIG. 3 shows a general arrangement of an illuminator system according to an embodiment of the present invention.

FIG. 4 shows an example of glints produced using the illuminator system according to an embodiment of the present invention.

FIGS. 5a and 5b show an example implementation of an illuminator according to an embodiment of the present invention.

FIGS. 6a and 6b show an example implementation of an illuminator according to an embodiment of the present invention.

FIG. 7 shows an example implementation of an illuminator according to an embodiment of the present invention.

FIGS. 8a and 8b show an example implementation of an illuminator according to an embodiment of the present invention.

FIG. 9 shows the effect of varying the size of the illuminator according to an embodiment of the present invention.

FIG. 10 depicts a method of glint detection according to an embodiment of the present invention.

### DETAILED DESCRIPTION

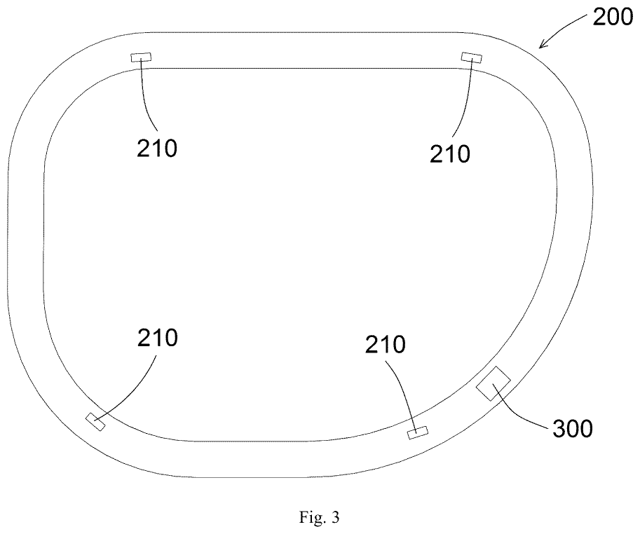

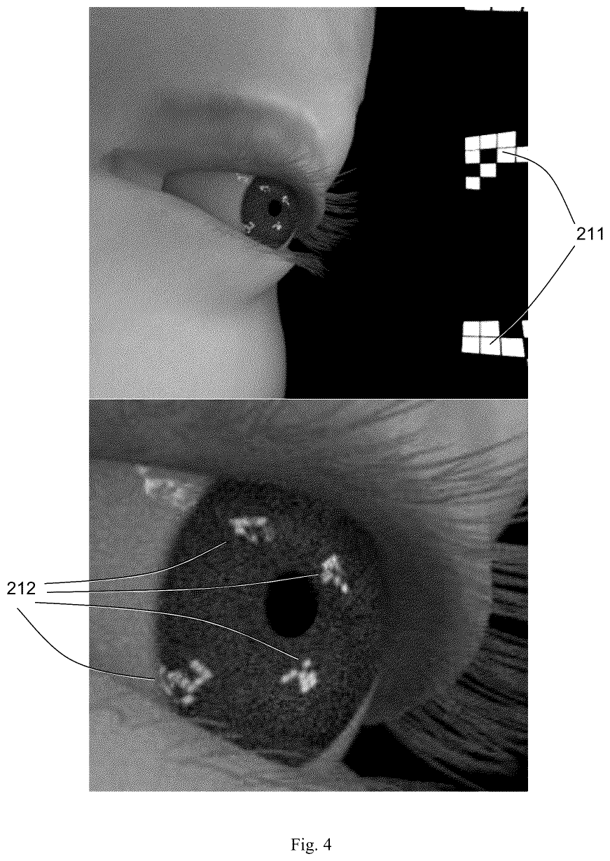

Referring to FIG. 3, the present invention is directed to an illuminator system 200 for an eye tracking system 100 for tracking movements of an eye. As shown, the system 200 comprises a plurality of illuminators 210. Each of the plurality of illuminators 210 is configured to emit light forming a respective predetermined reference pattern 211 as shown in FIG. 4. As shown in FIG. 4, the light emitted by the illuminators 210 is directed towards the user's eye, which in turn produces a number of reflections. When the light is reflected off the cornea of the eye, the reflective patterns form a number of glints 212.

As shown in FIG. 4, the reflected pattern of each of the plurality of illuminators 210 forms a single glint 212. That is, each reflected pattern appears as a single unit and is distinct from other reflected patterns. Furthermore, as shown in FIG. 4, the reference patterns 211 of at least two of the plurality of the illuminators 210 are different from each other. As a result, the reflected patterns 212 corresponding to these two illuminators 210 will also be different from each other. As a result, it is possible to distinguish one glint from another.

As shown in FIG. 4, the reference patterns 211 may be of a rectilinear type. That is, features of the reference pattern 211 may be in alignment with a square/rectangular grid. However, the reference patterns 211 are not limited to rectilinear patterns but may be any suitable patterns as long as at least two of them are different from each other. Of course, where more than two illuminators 210 are provided, the corresponding reference patterns 211 may all be different from one another.

Various known patters may be employed for this purpose. For example, patterns commonly used in fiducial marking may be used as the predetermined reference patterns 211. As known, a fiducial mark is an object placed in the field of view of an imaging system to serve as a point of reference or measure. Fiducials of known pattern and size can serve as real world anchors of location, orientation and scale. They can establish the identity of the scene or objects within the scene. Examples of rectilinear patterns include ARTag, AprilTag and ArUco. ARToolKit is an example of non-rectilinear patterns. In general, any arbitrary pattern may serve as a reference pattern 211 provided that it is distinguishable from other reference patterns 211, and that it produces a reflected pattern that forms a single glint 212 (as opposed to disparate speckles of light).

Each of the predetermined reference patterns 211 may be formed of a single segment of light (i.e. a single continuous region of light), or may be formed as several segments of light (i.e. several discreet regions of light, separated by regions without light). In the case that the reference pattern 211 is formed of multiple segments, the segments may be arranged such that the reflection of the reference pattern 211 forms a glint which is recognisable as a single glint. For example, the single glint may appear as a “mosaic glint”, namely that it has a recognisable mosaic pattern which is distinct from the other reflected patterns. In other words, the reference patters 211 may be arranged such that each of them produces a “glint symbol”, i.e. each reflected pattern may be recognisable as a single symbol rather than multiple disparate patterns. More generally, the reference patterns 211 may be arranged such that each of the reflected patterns has a glint shape or glint structure which allows the reflected pattern to be recognisable as a single glint rather than several disparate patterns.

In FIG. 3, four illuminators 210 are depicted. One way of ensuring that the reflected patterns from the illuminators 210 are recognisable as separate single glints 212 is to ensure that there is sufficient distance between any two illuminators 210. For example, the distance between any two illuminators 210 may be disproportionately larger than the size of each of the illuminators 210. More specifically, the separation between two illuminators 210 may be a multiple of the size of the largest of the predetermined reference patterns 211. For example, a multiple of at least 1.5, at least 2, or at least 3 maybe used. A larger multiple may be used, for example 10, 20 or 30.

The size of a reference pattern 211 may be defined in terms of the diameter of a bounding circle encompassing the reference pattern 211. Accordingly, the distance between two illuminators 210 may be defined in terms of the centre-to-centre distance between the respective bounding circles.

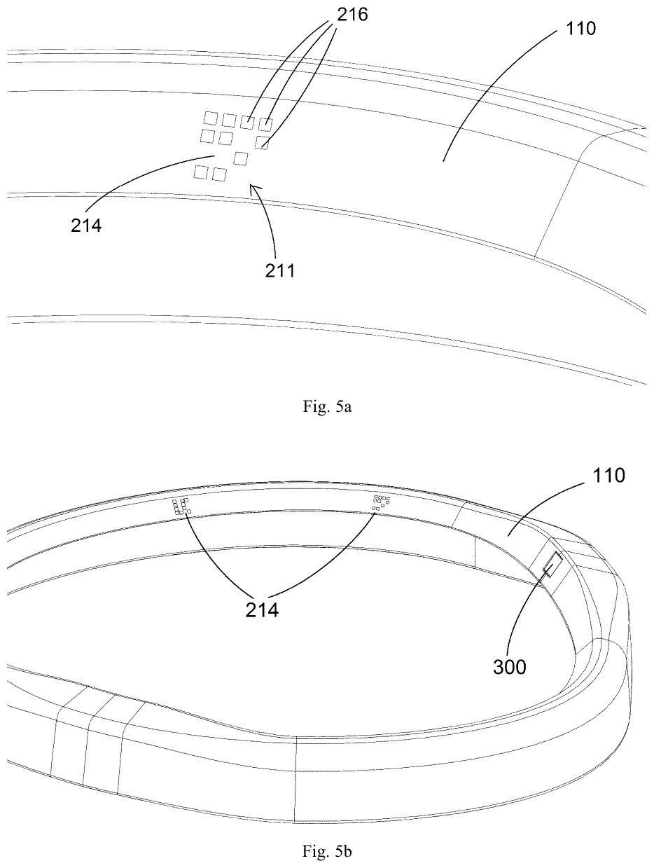

FIGS. 5 to 8 depict example implementations of the illuminator system 200.

In the examples of FIGS. 5 to 8, each of the plurality of illuminators 210 may comprise a light source 213, such as an LED. Other types of light sources such as lasers, in particular vertical-cavity surface-emitting lasers (VCSEL), may be used. In order to produce the respective predetermined reference patterns 211, each of the illuminators 210 may be provided with a cover 214 configured to selectively block light emitted by the light source 213. In other words, the cover may be provided with areas of relatively high light transmittance and areas of relative opaqueness, in accordance with the predetermined reference pattern 211.

In the simplest case, the pattern provided on the cover may have only two levels of opaqueness/transmittance, so that the resulting reference patters 211 is effectively monochrome. However, it is possible for the cover to be provided with areas of intermediate opaqueness/transmittance, so that the resulting reference pattern 211 has multiple levels of brightness.

Furthermore, as mentioned above, as the light source 213 also serves the purpose of illuminating the eye for image capture, the light source 213 may produce non-visible light, such as infrared light. In particular, near-infrared (NIR) light (e.g. 750 to 1,400 nm wavelength) may be used. For example, the light source 213 may be an LED emitting NIR light. Alternatively, the light source 213 may produce light within a broader spectral band, and may comprise a light filter to prevent light other than NIR light from being emitted.

As shown in FIGS. 5a and 5b, the cover 214 may be implemented as a part of a casing 110 of the eye-tracking system 100. As shown in FIG. 5a, the cover 214 may be integrally provided with the casing 110. As shown, several covers 214 may be integrally provided in the same part of the casing 110. As shown in FIG. 5b, the covers 214 may be provided on an inward-facing wall of the casing 110 which forms a ring around the eye. In one implementation, a separate light source 213 (e.g. an LED) may be provided behind each of the covers 214.

The casing 110 with integrated covers 214, as shown in FIGS. 5a and 5b, may be manufactured by first forming (e.g. by moulding) the entire casing 110 out of an optically transmissive material, then coating one side (e.g. the external side, facing the user) of the casing 110 with an opaque material (e.g. paint), then finally selectively etching or burning away (e.g. using laser) the coating so as to form the required reference pattern 211.

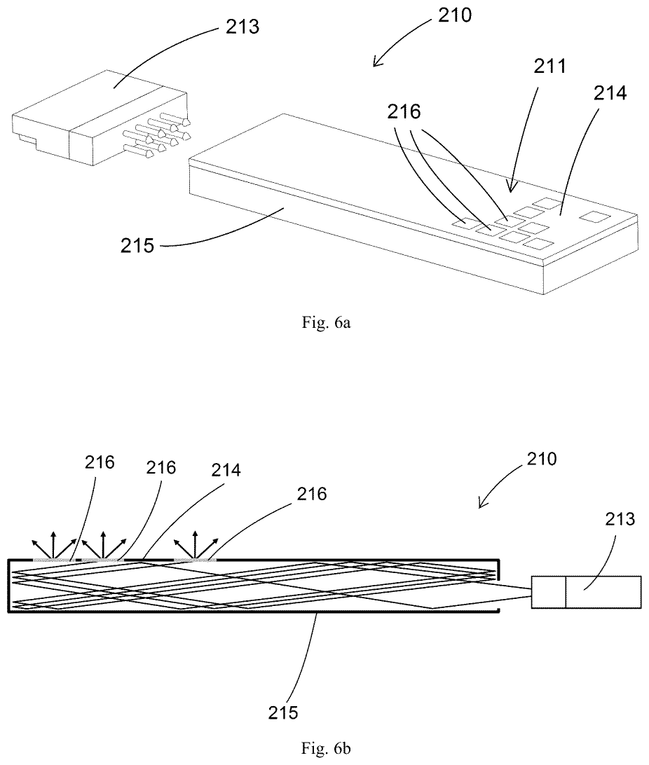

Alternatively, as shown in FIGS. 6a and 6b, the light source 213 may emit light indirectly towards the cover 214 via a light guide 215. As shown, light emitted by the light source 213 passes through the light guide 215 before reaching the cover 214, on which the reference pattern 211 is provided. As above, the cover 214 allows light to pass therethrough at locations where areas of relatively high light transmittance are arranged according to the reference pattern 211. As shown in FIG. 6b, after the light from the light source 213 has entered the light guide 215, it may undergo a number of internal reflections within the light guide 215 before exiting via the cover 214. The use of internal reflections may help distribute the light more evenly, so that the emitted light forming the reference pattern 211 has substantially uniform intensity. Furthermore, the light guide 215 may be covered with a light-reflective coating (except where light is required to exit) in order to reduce or prevent leakage of light. This may make more efficient use of the light emitted by the light source 213, thereby reducing power consumption.

As shown in FIGS. 6a and 6b, the light from the light source 213 may enter the light guide 215 in a direction substantially different from, or perpendicular to, the direction in which the cover 214 faces. That is, the direction in which light from the light source 213 enters the light guide 215 may be substantially different from, or perpendicular to, a vector normal to the surface of the cover 214. This arrangement may reduce the physical profile of the illuminator 210 as a whole. That is, instead of stacking a light source 213 directly behind the cover 214, by arranging the light source 213 to be laterally displaced from the cover 214, the thickness of the illuminator 210 as a whole may be reduced. This arrangement also advantageously makes use of the otherwise empty space within the casing 110 of the eye-tracking system 100 between two illuminators 210.

FIGS. 6a and 6b depict an arrangement in which one light source 213 is provided for every illuminator 210. However, it is possible for two or more of the illuminators to share a common light source 213. This may be achieved by directing the light from the light source 213 into a shared light guide 215, and by providing two or more covers 214 on the shared light guide 215. Each of the covers 214 provided on the shared light guide may selectively block light from exiting the light guide 215 to form the respective predetermined reference patterns 211. As noted above, at least two of the predetermined reference patterns 211 are different from each other. With this arrangement, each light source 213 may emit the light necessary for forming two or more predetermined reference patterns. This may reduce the number of light sources 213 required in the illuminator system 200.

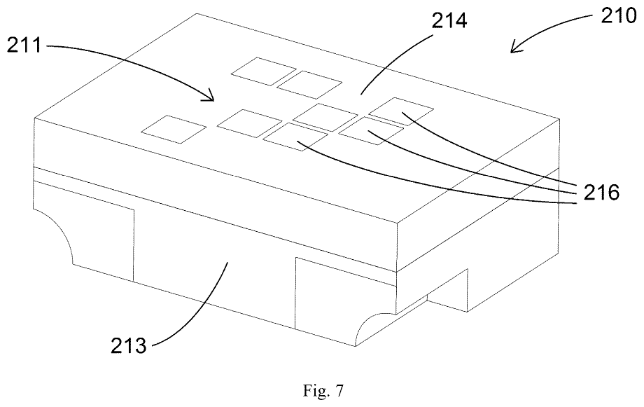

FIG. 7 shows another example implementation of the illuminators 210. As shown, the cover 214 is provided with the light source 213 as a single assembly. For example, the cover 214 may be mechanically fastened to the light source 213, and/or may be bonded to the light source 213 using an adhesive. As another examine, the cover 214 may be implemented as a coating provided on the light source 213. Advantageously, the illuminator 210 shown in FIG. 7 maybe mass-produced as standardised components with a selection of different predetermined patterns 211. The illuminator 210 may be attached to the eye-tracking system 100 in physical positions such as shown in FIG. 5b, except that the cover 214 would not be integrally provided with the casing 110 of the eye-tracking system 100.

As noted above, in the example implementations of FIGS. 5 to 7, a cover 214 is provided to selectively block light emitted from the light source 213 in order to form the respective predetermined reference patterns 211. This may be achieved by providing at least one window 216 in the cover 214. The windows 216 may allow light forming the predetermined reference pattern to pass through. Furthermore, the widows 216 may be optically diffuse, so that the reference pattern 211 will have even brightness. In particular, the windows 216 may be sufficiently optically diffuse so that the emitted light forming the reference pattern 211 may have substantially uniform light intensity. In particular, the windows 216 may be configured to ensure that the light intensity of the reference pattern 211 is substantially uniform in all directions pointing towards a region on the eye within which the pupil may move. Of course, the windows 216 may evenly distribute light to a larger region, such as the entire eye area, or even within the whole hemisphere on the outside of the illuminator 210.

The cover 214 may be manufactured by first forming the cover 214 out of an optically transmissive but diffuse material (e.g. a plastics material), followed by coating the cover 214 with an opaque material (e.g. paint), then selectively etching or burning away (e.g. using laser) some of the opaque material so as to form the windows 216.

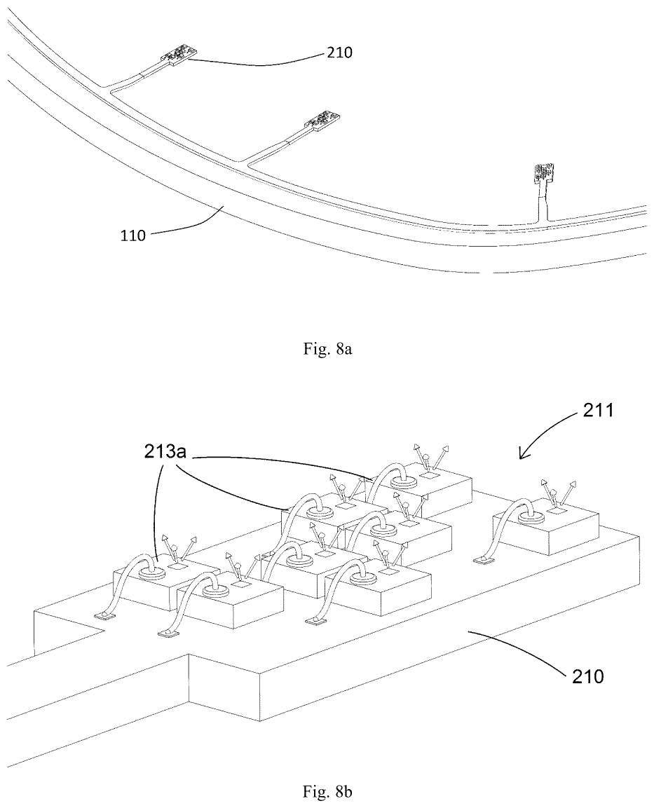

FIGS. 8a and 8b depict another example implementation of the illuminators 210. As shown in FIG. 8b, each illuminator 210 is provided with a plurality of light sources 213a. As shown, the plurality of light sources 213a may be positioned to form the required reference pattern 211. As shown, the plurality of light sources 213a are arranged in a rectilinear fashion, so that they align to a rectangular grid. However, as noted above, the reference patterns 211 need not be of a rectilinear type. Therefore, the plurality of light sources 213a may be arranged arbitrarily and not in alignment to a rectangular or square grid (or indeed any regular grid), so long as the reference pattern 211 differs from one illuminator 210 to another.

Compared with using a single light source per illuminator 210, the plurality of light sources 213a in this example arrangement may individually have a lower power output. Because power output is lower, cheaper individual light sources 213a may be used. Of course, it is possible to achieve a lower power output by under-driving the light sources 213a. The combined light output of the plurality of light sources 213a may be similar to the example arrangements shown in FIGS. 5 to 7.

In this arrangement, because all of the light emitted by the light sources 213a is emitted towards the eye without any of it being blocked or otherwise absorbed, this arrangement may be more energy efficient.

As shown in FIG. 8b, all of the light sources 213a may be positioned to form the predetermined reference pattern 211. That is, in areas where no light is required, no light source need be provided. In other words, the number of light sources 213a required may be exactly the number required to produce the predetermined reference pattern 211. In this arrangement, in order to achieve different reference patterns 211 between the plurality of illuminators 210, the plurality of light sources 213a may be arranged differently for each of the illuminators 210. This is so that each of the illuminators 210 will produce a different reference pattern 211.

In some situations, the manufacturing process required to produce illuminators 210 with different arrangements of light sources 213a may be complex. Therefore, as an alternative to the arrangement shown in FIG. 8b, the illuminators 210 may all have the same arrangement of light sources 213a, except that the light sources 213a are selectively rendered non-operable so as to achieve the required different reference patterns 211. For example, the common arrangement of the light sources 213a may form a regular matrix. This arrangement may simplify the manufacturing process because the same arrangement of light sources 213a may be used across all of the plurality of illuminators 210.

To make a light source 213a non-operable, during manufacturing, the light source 213a may simply be not provided with a connection to the electrical supply. Alternatively, all of the light sources 213a may initially be connected, and the manufacturing process may include an additional step of severing the connections of the light sources 213a which are required to be non-operable.

As noted above, the plurality of light sources 213a may be arranged in an invariable matrix for all of the illuminators 210. However, as an alternative to rendering some of the light sources 213a non-operable, the required reference pattern 211 for each illuminator 201 may be formed by selectively operating some of the plurality of light sources 213a. This arrangement also has the advantage that only one design of illuminators 210 need be manufactured, which may reduce the complexity of the manufacturing process. Another advantage of this arrangement may be that the reference patterns 211 can be changed during use of the eye-tracking system 100. For example, this may be useful for adapting to different external light conditions.

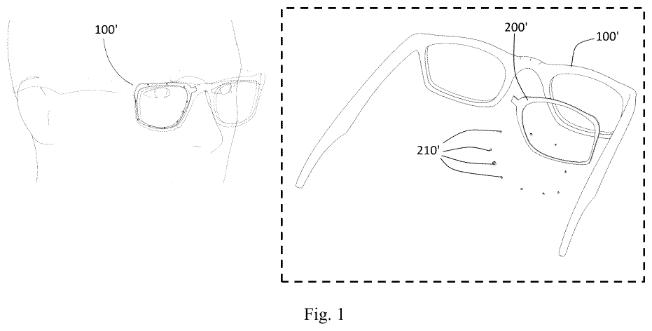

As noted above, at least two of the reference patterns 211 should be different from each other, so that their corresponding glints can be distinguished from one another. A further benefit of this arrangement is that it may allow each glint 212 to be readily matched to the corresponding reference pattern 211. In a prior-art system 100′ such as shown in FIG. 1, in which a plurality of point-source illuminators 210′ are used, glint matching is difficult and sometimes impossible. This is because, in prior-art systems 100′, in order to perform glint matching, it is necessary to compare the geometric relationship amongst the captured glints with the geometric disposition of the illuminators 210′, and from this comparison deduce which glint comes from which illuminator 210′. In general, even when unwanted artefacts (such as secondary reflections from prescription glasses or contact lenses) are largely absent, a large number of illuminators 210′ is necessary for useful glint matching, which, as noted above, is a cause for high power consumption.

A further cause for high power consumption associated with glint matching using prior-art systems 100′ is that substantial amount of computer processing is necessary for this type of glint matching. This is due to the need to analyse substantially the entire image segment containing the pupil region, and the corneal reflections (which may contain an unknown number and formation of glints) generally do not have a predictable pattern. That is, it is difficult to know a priori what pattern to expect in the corneal reflections. As a result, machine learning modules cannot be trained to search for glints by simply recognising specific patterns that are known a priori. Instead, complex and power-consuming algorithms are needed and must analyse the whole image segment, and even then the reliability of glint matching is poor.

By contrast, with the present invention, because each glint 212 has a unique pattern which is known a priori, for the purpose of glint matching, it may be computationally less demanding to recognise the pattern of a glint 212. This is because machine learning algorithms can be computationally efficient in recognising set patterns, and the use of the predetermined patterns 211 according to the present invention may enable the machine learning module to be specifically trained on these patterns. In other words, with the use of the predetermined patterns 211, the machine learning module may have a much more specific and well-defined task, which may lend itself to an implementation which requires little memory and processing power. This may in turn result in a lower power consumption associated with glint matching.

Furthermore, given the improved reliability in glint matching, it may be possible to use a small number of illuminators 210 whilst still maintaining adequate glint matching reliability. For example, as will be discussed in more detail below, as few as four illuminators 210 may be used.

As a further effect, with the present invention, it may be necessary to analyse only the image segments containing the glints 212. Because the total area of the image segments containing the glints 212 tends to be much smaller than the area of an image segment containing the entire pupil region, the amount of image data that needs to be analysed can be substantially reduced. Therefore, the processing power required may be reduced, which may in turn reduce the power consumption associated with glint matching.

To further ensure uniqueness of the reference patterns 211, they may be different from one another in the sense that none of the reference patterns 211 is a scaled or rotated version of another one of the reference patterns 211. This may be useful, for example, in case the user wears prescription glasses, which may produce complex reflections that rotate and/or scale the reference patterns 211. Therefore, by ensuring that none of the reference patterns 211 is a scaled or rotated version of another reference pattern 211, the glints 212 can be reliably distinguished from one another.

To further ensure uniqueness of the reference patterns 211, each of the reference patterns may be configured so that it has no rotational symmetry.

As noted above, one of the drawbacks of prior-art systems is that it is sometimes difficult to distinguish genuine glints from unwanted artefacts. In prior-art systems, one approach to addressing this drawback is to employ smaller light sources (and thus increasing the light intensity), so that the glints are significantly brighter than the general level of illumination provided to the eye area by the same light sources. That is, since the prior-art light sources have no other feature than being point-like, the glints can be made to be more recognisable by making them smaller and more intense. However, this approach creates another drawback which is that the glints may become over-exposed in the images captured by the camera. That is, given the limited dynamic range of the camera, it may be difficult to set the exposure level of the camera such that the dynamic range is used efficiently while preventing the image from being saturated by the extra-bright glints. When a glint is saturated, its outline becomes less defined and its centre may become more difficult to compute reliably. Therefore, saturation may add a degree of uncertainty in the determination of glint positions, which may in turn result in poor gaze estimation and poor eye-tracking reliability. We refer to this as the “exposure problem”.

In certain applications of prior-art systems, for example in AR glasses, a further technique which may be employed to make the genuine glints more distinguishable from unwanted artefacts is to increase the power level of the illuminators. This may produce glints which are brighter in comparison with external light sources. However, this may exacerbate the exposure problem.

In other words, prior-art systems are limited by the trade-off between glint detection accuracy and gaze estimation accuracy. That is, the brighter (i.e. greater intensity, but not necessarily greater light power) the glints, the more reliable the glint detection but gaze estimation reliability suffers. Conversely, reducing the brightness of the glints may improve the image quality of the features of the pupil/iris region, which is necessary for gaze estimation, but glint detection accuracy suffers. Without reliable glint detection, as noted above, gaze estimation also becomes unreliable. As a further drawback, increasing the brightness of the glints also increases power consumption.

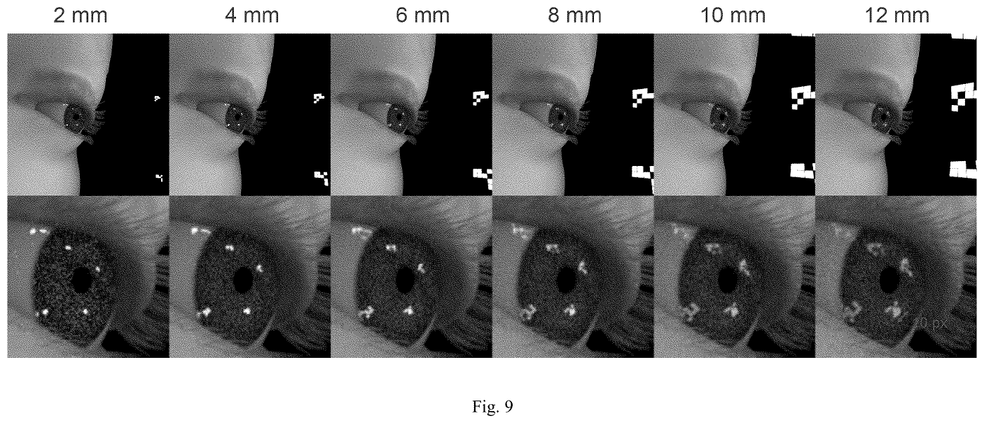

In order to address the exposure problem, the reference pattern 211 of each of the illuminators 210 may be sufficiently large. For example, the reference patterns 211 may be at least 2 mm, at least 4 mm, at least 6 mm, at least 8 mm, at least 10 mm, or at least 12 mm in length and width. FIG. 9 shows the effect of increasing the size of the reference patterns 211 whilst maintaining the overall light output of the illuminators 210. As shown, as the size of the reference patterns 211 increase from 2 mm up to 12 mm, the glints 212 become progressively larger but less bright. Because the total light output remains substantially constant, the level of illumination provided to the eye area remains constant. As a result, the brightness contrast between the glints 212 and the iris/pupil region reduces as the size of the reference patterns 211 increases. A lower contrast addresses the exposure problem because the camera is able to adjust its dynamic range so that the glints are not over-exposed and the iris/pupil region is sufficiently bright to produce a high-quality image. Since both the glints 212 and the image of the iris/pupil region are necessary for successful gaze estimation, by reducing the contrast between the glints and the iris/pupil region, their reliability of gaze estimation may be improved.

As would be appreciated, although increasing the size of the reference patterns 211 may address the exposure problem, it may not be desirable to increase the size of the reference patterns 211 to an arbitrarily large size. For example, the large size of the reference patterns 211 may result in a bulkier illumination system 200 because the casing 110 would have to large enough to accommodate the larger illuminators 210. In addition, as the size of the reference patterns 211 increases, the risk of the reflected patterns colliding also increases.

This is especially the case if the user wears prescription glasses. Therefore, whilst it may be advantageous to address the exposure problem, it may also be desirable to limit the size of the reference patterns 211. For example, the size of the reference pattern 211 may be no more than 12 mm, no more than 8 mm, no more than 6 mm, no more than 4 mm, or no more than 2 mm.

In the examples shown in the figures, the reference patterns 211 are shown to have generally equal length and width (i.e. they have a generally square outline). However, it may be advantageous to employ reference patterns 211 which have a length that is not equal to its width. That is, each of the reference patterns 211 may have a generally rectangular outline. This may be advantageous because larger reference patterns 211 may be accommodated without increasing the thickness of the casing 110 housing the illuminator system 200. As such, the exposure problem may be more effectively addressed without rendering the eye-tracking system 100 bulkier.

As noted above, depending on the relative position and orientation of the eyeball, some of the reflected patterns may fall outside the iris/pupil region, and these reflections will not produce glints. Therefore, if only two illuminators 210 are provided, it is possible that, in some extreme angular position of the eyeball, no glint will be produced and gaze estimation may fail. Therefore, it may be desirable to provide more than two illuminators 210 so as to increase the likelihood that at least one detectable glint (per eye) is produced. For example, the number of illuminators 210 may be three or more, four or more, five or more, six or more, seven or more, eight or more, nine or more, or ten or more. More preferably, it may be desirable to provide four illuminators 210 (as shown in FIG. 3), or five or more illuminators 210. With this number of illuminators 210, in most practical situations, at least two detectable glints would be produced. However, in order the limit power consumption, it may be desirable to employ a smaller number of illuminators 210. For example, the number of illuminators 210 may be no more than ten, no more than nine, no more than eight, no more than seven, no more than six, no more than five, no more than four, or no more than three.

As shown in FIG. 3, the illuminators 210 may be substantially evenly distributed to surround the eye. This may ensure that reference patterns 211 are projected onto the eye from a variety of different directions, so that, irrespective of the relative position and orientation of the eyeball, one or more glint will be reliably produced.

The present invention is also directed to a complete eye-tracking system comprising the illuminator system 200. Depending on the implementation of the illuminator system 200, the illuminator system 200 may be attached to or integrated in the eye-tracking system 100. As noted above, the eye-tracking system 100 may comprise a pair of extended reality (XR) headset.

As noted above, in order to perform glint detection and gaze estimation, the eye-tracking system 100 may comprise an image sensor 300 (or camera) configured to capture an image of an eye, the image comprising one or more glints. The captured image may include features of the iris/pupil region, which may be necessary for gaze estimation. As shown in FIGS. 3 and 5b, the image sensor 300 may be provided within the same casing 110 as the illuminators 210.

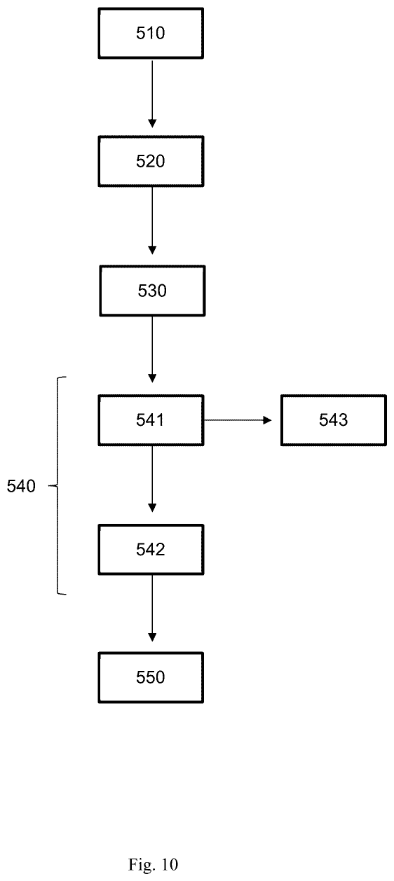

In order to perform glint detection, the eye-tracking system may further comprise a controller (not shown) communicating with the image sensor 300. The controller may be used to analyse the image captured by the image sensor 300. Referring to FIG. 10, after light forming the reference patterns 211 has been emitted at step 510, the image sensor 300 may capture an image of one or more of the glints 212 at step 520. The image may include features of the iris/pupil region. The image sensor 300 may transmit the captured images to the controller.

At step 530, the controller may analyse the captured images. Specifically, the controller may recognise the one or more glints 212 present in the captured images. For example, the controller may recognise the glints 212 by searching for image features that match the expected attributes of a glint 212. The controller may perform the recognition of one or more glints using image processing techniques, optionally in conjunction with machine learning algorithms. For example, glints 212 may have an expected general outline shape. The expected outline shape may be known based on the predetermined reference patterns stored on the controller and based on the known curvature of the cornea of the eye. Therefore, image features which appear to be glints but are heavily distorted may be excluded as possible candidates for genuine glints.

At step 540, the controller may compare the one of more recognised glints with the predetermined reference patterns 211 stored on the controller. The controller may compare each of the recognised glints with each of the predetermined reference patterns 211 that are known to be present in the illuminator system 200, so as to find the reference pattern 211 that matches the glint being compared. If a match is found, at step 550, the controller may associate the glint with the matching reference pattern 211. Therefore, with this arrangement, it is possible not only to detect the glints, but also to distinguish one glint from another. This may provide further certainty in the glint detection, which may in turn improve the reliability of gaze estimation.

As noted above, especially if the user is wearing prescription glasses, the images captured by the image sensor 300 may include numerous artefacts resulting from the reflection of the emitted light by the prescription glasses. Otherwise, artefacts may result from external light sources. As noted above, reflections produced by prescription glasses generally are distorted and have an apparent size which is inconsistent with genuine glints. Therefore, the step (step 540) of comparing the glints with the predetermined reference patterns may comprise determining the apparent size of each glint at step 541. The controller may determine that the glint is genuine if its apparent size falls within a predetermined size range, at step 542. On the contrary, the controller may determine that the glint is an artefact if its apparent size falls outside the predetermined range, at step 543. The predetermined size range may be known in advance based on the stored predetermined reference patterns and the known approximate curvature of the cornea of the eye.

The controller may be an embedded device within the eye-tracking system 100. Alternatively, the controller may be not embedded, but connected to image sensor 300 using a wired or wireless connection. For example, the controller may be provided in a separate unit that communicates with the extended reality headset (or another wearable component of the eye-tracking system 100).

Another aspect of the present invention is directed to a computer program comprising instructions to cause an eye-tracking system 100 to perform the method shown in FIG. 10. Another aspect of the present invention is directed to a computer-readable medium having stored there on the computer program.

1. An illuminator system for an eye-tracking system for tracking movements of an eye, the system comprising a plurality of illuminators;
wherein each of the plurality of illuminators is configured to emit light forming a respective predetermined reference pattern;
wherein each of the reference patterns, when reflected off the cornea of the eye, produces a respective reflected pattern forming a single glint;
wherein the reference patterns of at least two of the plurality of the illuminators are different from each other.

2. The illuminator system of claim 1, wherein each of the plurality of illuminators comprises:
a light source; and
a cover configured to selectively block light emitted by the light source to form the respective predetermined reference pattern and/or wherein, the cover is part of a casing of the eye-tracking system.

3. The illuminator system of claim 2, wherein, in each of the plurality of illuminators:
the illuminator further comprises a light guide between the light source and the cover, so that light from the light source passes through the light guide before reaching the cover.

4. The illuminator system of claim 3, wherein at least two of the illuminators have a shared light source and a shared light guide, so that light from the shared light source passes through the shared light guide before reaching the respective covers of the at least two illuminators.

5. The illuminator system of claim 2, wherein, in each of the plurality of illuminators:
the cover comprises at least one window configured to allow the light forming the predetermined reference pattern to pass therethrough; and
the at least one window is optically diffuse.

6. The illuminator system of claim 5, wherein the one or more window is configured to diffuse the light passing therethrough to achieve a substantially uniform light intensity.

7. The illuminator system of claim 1, wherein each of the plurality of illuminators comprises a plurality of light sources positioned to form the respective predetermined reference pattern, wherein all of the light sources in each of the plurality of illuminators are positioned to form the respective predetermined reference pattern.

8. The illuminator system of claim 7, wherein each of the plurality of illuminators comprises further light sources which are non-operable and do not form part of the respective predetermined reference pattern.

9. The illuminator system of claim 7, wherein the plurality of light sources is arranged in a matrix, and the plurality of light sources are selectively operable to form the predetermined reference pattern.

10. The illuminator system of claim 1, wherein none of the predetermined reference patterns is a scaled or rotated version of another one of the predetermined reference patterns.

11. The illuminator system of claim 1, wherein each of the predetermined reference patterns has no rotational symmetry.

12. The illuminator system of claim 1, wherein the reference pattern of each of the illuminators is at least 2 mm in length and width, wherein a length is not equal to its width.

13. The illuminator system of claim 1, wherein the plurality of illuminators comprises at least four illuminators.

14. An eye-tracking system comprising the illuminator system of claim 1 and an image sensor configured to capture an image of one or more of the glints.

15. The eye-tracking system of claim 14, comprising an extended reality headset; wherein the illuminator system is attached to or integrated in the extended reality headset.

16. The eye-tracking system of claim 14, wherein the plurality of illuminators are arranged to surround the eye.

17. The eye-tracking system of claim 14, further comprising a controller having stored thereon the predetermined reference patterns; wherein the controller is configured to:
recognise the one or more glints present in the captured image;
compare the one or more glints with the predetermined reference patterns; and
associate each of the one or more glints with a matching one of the predetermined reference patterns.

18. The eye-tracking system of claim 14, wherein the controller is further configured to, for each of the one or more glints:
determine the apparent size of the glint;
determine the glint as genuine if its apparent size falls within a predetermined size range; and
determine the glint as an artefact if its apparent size falls outside the predetermined size range.

19. A non-transitory computer-readable medium having stored thereon a computer program comprising instructions to cause the system of claim 14 to execute the steps of:
capturing an image of one or more of the glints;
recognising the one or more glints present in the captured image;
comparing the one or more glints with the predetermined reference patterns; and
associating each of the one or more glints with a matching one of the predetermined reference patterns.

20. The non-transitory computer-readable medium of claim 19, comprising further instructions to cause the system of claim 14 to execute the steps of:
determining the apparent size of the glint;
determining the glint as genuine if its apparent size falls within a predetermined size range; and
determining the glint as an artefact if its apparent size falls outside the predetermined size range.
